(19) United States
(12) Patent Application Publication
(10) Pub. No.: US 2012/0283985 A1
(43) Pub. Date: Nov. 8, 2012

(54) NON-INVASIVE SPEED SENSOR

(75) Inventor: Thomas Schubert, Fort Mill, SC (US)

(73) Assignee: SCHAEFFLER TECHNOLOGIES AG & CO. KG, Herzogenaurach (DE)

(21) Appl. No.: 13/505,570

(22) PCT Filed: Nov. 11, 2010
(86) PCT No.: PCT/EP2010/067288

§ 371 Date: May 2, 2012

Related U.S. Application Data
(60) Provisional application No. 61/261,224, filed on Nov. 13, 2009.

(51) Int. Cl. G01P 3/36; G06F 15/00

(52) U.S. Cl. 702/145; 356/28

(57) ABSTRACT

The invention relates to a method of measuring rotational speed of a shaft, comprising the steps of: coupling an optical pickup to a shaft speed sensor having an indicator light that pulses proportionally to rotational speed of a shaft being measured by the speed sensor; receiving light pulses from the indicator light of the speed sensor; and determining the rotational speed based on the rate of received light pulses. Furthermore, the invention discloses a condition monitoring equipment for a wind turbine using the above measuring method.

### TECHNICAL FIELD

The invention relates to shaft speed sensing for various applications such as wind turbine monitoring.

### BACKGROUND OF THE INVENTION

Wind turbines are machines used to convert wind power to electrical power. Often, wind turbines use propellers or turbine blades to drive a gearbox, rotor shaft, and a generator (or other mechanical elements) that ultimately produces electricity. After a period of operation, the mechanical elements used by wind turbines may need to be monitored for abnormal behavior, predictive maintenance, or warranty checks. Condition monitoring (CM) equipment can be installed that provides feedback about the operational condition of the wind turbines. However, linking CM equipment to wind turbines can be a labor-intensive task that involves equipment having a wide range of components. This equipment can typically include a processor, non-volatile memory, as well as various sensors that are coupled to the wind turbine or specific components thereof. These sensors can include a speed sensor for measuring turbine speed, accelerometers for measuring vibration, and a current monitor for determining turbine load.

### SUMMARY

A method of measuring a rotational speed of a shaft is provided, which includes coupling an optical pick-up to a shaft speed sensor having an indicator light that pulses proportionally to a rotational speed of a shaft being measured by the speed sensor, receiving light pulses from the indicator light, and determining the rotational speed based on a rate of received light pulses.

### BRIEF DESCRIPTION OF THE DRAWINGS

Preferred exemplary embodiments of the invention will hereinafter be described in conjunction with the appended drawings, wherein like designations denote like elements, and wherein:

FIG. 1 is a photo depicting portions of a wind turbine and diagrammatically depicts the internal wind turbine shaft in broken lines;

FIG. 2 is a diagram showing an internal speed sensor and CM equipment including an optical pickup and interface circuit for monitoring pulses of an indicator LED of the speed sensor;

FIG. 3 depicts examples of speed sensors; and

FIG. 4 is a block diagram of the interface circuit of FIG. 2.

### DETAILED DESCRIPTION OF THE PREFERRED EMBODIMENTS

Although the present invention can be utilized in conjunction with a wide variety of machines to detect rotational speed of a shaft or other element, one exemplary embodiment is described below as it would be used as a part of condition monitoring (CM) equipment for wind turbines.

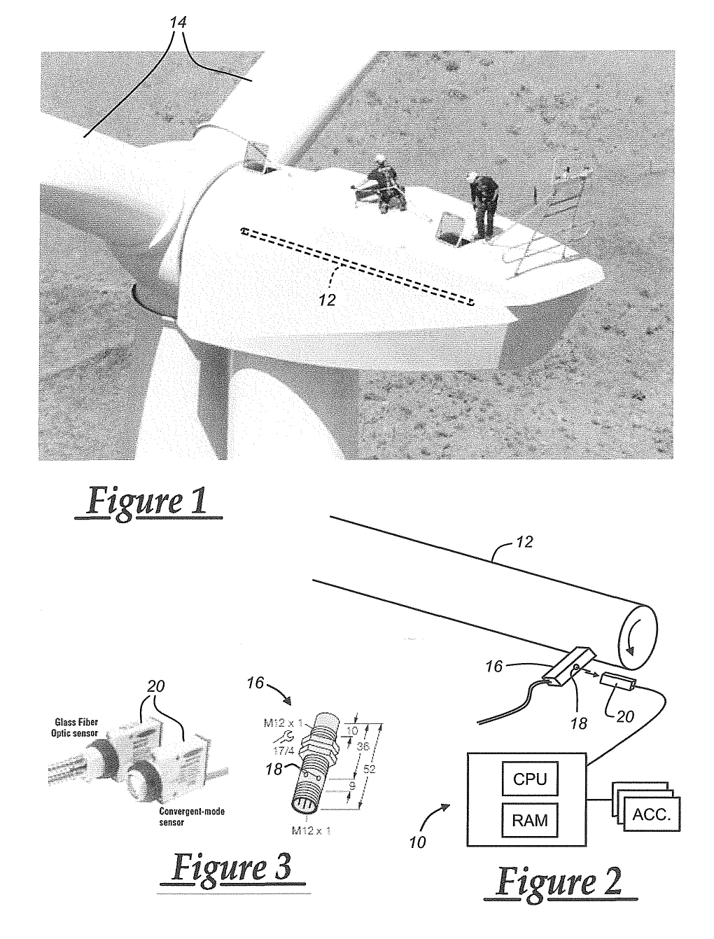

A section of one wind turbine design is generally shown at in FIG. 1. The wind turbine includes a drive shaft 12 that carries turbine blades 14. The drive shaft 12 connects at one end to a generator (not shown). As wind acts on the blades 14, the shaft 12 rotates powering the generator and creating electricity. Referring now also to FIG. 2, the wind turbine includes a wind turbine speed sensor 16 that monitors the speed of the drive shaft 12 as part of wind turbine operation. This sensor 16 is an existing sensor onboard the wind turbine and is not a part of the CM equipment itself which will be described below. The speed sensor 16 can be of the type that includes at least one light-emitting diode (LED) 18 that outputs light pulses with a frequency equal or proportional to the rotational speed of the drive shaft 12.

The CM equipment 10 can be temporarily or permanently installed on the wind turbine to gather data about the turbine over a period of time. For temporary installations, the equipment is installed for a period of time and then removed by a technician. As shown in FIG. 2, the CM equipment 10 includes a processor, digital memory (e.g., ROM, RAM, NVRAM, etc.), a plurality of accelerometers, an optical pickup 20, and a sensor interface 22 for the optical pickup. Other components can be included as well; for example, a generator current monitor. As will be appreciated by those skilled in the art, the processor, memory, and accelerometers can all be hardware components that are commercially available and can be interconnected and controlled via software to obtain vibration and other such acceleration data from various points or components on the wind turbine. When installing the CM equipment 10, the optical sensor 20 is located adjacent the LED indicator 18 such that it can detect light pulses emitted from the LED and communicate that information to the processor (CPU). This can be done by clipping the optical sensor 20 onto the speed sensor 16 or otherwise mounting it in sufficiently close proximity to detect the LED light pusles.

As is known, the speed sensor 16 sends an electronic signal each time the drive shaft 12 rotates a predetermined distance. In one embodiment, the speed sensor 16 is an inductive type that is used in combination with one or more magnetic or ferromagnetic features on the shaft 12 to detect incremental rotation of the shaft. For example, the drive shaft 12 can include a plurality of ferrous teeth (not shown) that encircle the shaft. The ferrous tooth/teeth can be bumps or locations on the drive shaft 12 that have an increased amount of material relative to the area(s) next to the tooth. Each tooth is an equally-spaced and predetermined distance from the nearest tooth. As the drive shaft 12 rotates about an axis 22, the teeth rotate as well. The speed sensor 16 generates and monitors an inductive magnetic field which is influenced by the passing teeth in a detectable way so that the speed sensor provides an output signal indicative of shaft rotation. By knowing the amount of distance between the teeth (or the number of teeth circumscribing the shaft) and the amount of time passed between sensing the presence of teeth, the wind turbine circuitry can determine the rotational speed of the shaft 12. This data is used by the wind turbine generator in a manner known in the art.

The speed sensor 16 also uses the detected inductive pulses to pulse the LED indicator 18. Since the optical pickup 20 is positioned to detect the light pulses emitted by the LED, then each time the speed sensor 16 activates the LED 18, the optical pickup 20 detects this and generates a signal of its own. This signal is filtered, amplified, and conditioned by the interface circuit 22 to provide a pulse train having a pulse repetition rate that is indicative of shaft speed. Thus, based on the pulse rate, the CM equipment processor can determine and record the rotational speed of shaft 12. As shown in FIG. 2, the pickup can be mounted in close proximity to the LED 18 in such a way to accurately receive the light emitted from the LED. Turning to FIG. 3, examples of speed sensors 16 are shown. As noted above and shown in FIG. 3, the speed sensor 16 can be, for example, an inductive type that includes an M12 connector and a plurality of LEDs 18 located on the exterior of the sensor 16. Alternatively, a glass fiber optic sensor or convergent-mode sensor can be used as shown in FIG. 3. These also include an indicating LED (not shown). Or, any other suitable sensor can be used that provides a detectable optical output that pulses at a rate dependent on the rotational speed of shaft 12.

FIG. 4 depicts the a block diagram of the interface circuit 22. As shown, the optical pickup 20 can be implemented using a photo diode that changes its conduction characteristic based on received light. The interface circuit 22 includes a signal output that goes to the remainder of the CM equipment 10 for use in condition monitoring of the wind turbine. It also includes an auxiliary output that can be used for other purposes, such as to provide remote real-time monitoring of the turbine speed via cellular or other wireless communication.

By incorporating an optical pickup in sight of the LED indicator of the speed sensor, the CM equipment can monitor turbine shaft speed without any physical interconnection to the shaft and without the provision of any special additional features to the shaft itself. This can help reduce the cost of the CM equipment and can help expedite the installation and removal of the CM equipment. Monitoring of the speed sensor indicator LED by the optical pickup also allows for diagnosis of problems with the wind turbine speed sensor.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. For example, any suitable shaft speed sensor can be used as long as it provides an optical indication of the shaft rotational speed that can be detected by the optical pickup. All such other embodiments, changes, and modifications are intended to come within the scope of the appended claims.

As used in this specification and claims, the terms “for example,” “for instance,” and “such as,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of measuring rotational speed of a shaft, comprising the steps of:
coupling an optical pickup to a shaft speed sensor having an indicator light that pulses proportionally to a rotational speed of a shaft being measured by the speed sensor;
receiving light pulses from the indicator light of the speed sensor; and
determining the rotational speed based on a rate of received light pulses.

2. The method of claim 1, wherein the coupling step further comprises coupling the optical pickup to an existing speed sensor at a shaft of a wind turbine.

3. A wind turbine condition monitoring system, comprising:
a processor;
a digital memory having a program stored thereon and being accessible by the processor; and
a plurality of sensors that provide data to the processor, the sensors including accelerometers and an optical pickup, wherein the processor is operable under control of the program to determine a rotational speed of the wind turbine based on light pulses received by the optical pickup.

4. A wind turbine condition monitoring system as defined in claim 3, further comprising an interface circuit coupled between the optical pickup and processor, said interface circuit being operable to output shaped pulses based on input received by the interface circuit from the optical pickup.
